(19) United States
(12) Patent Application Publication
(10) Pub. No.: US 2010/0301205 A1
(43) Pub. Date: Dec. 2, 2010

(54) LINEAR ION TRAP FOR MSMS

(76) Inventor: Bruce Thomson, Toronto (CA)

Correspondence Address: PERRY + CURRIER INC., 1300 YONGE STREET, SUITE 500, TORONTO, ON, M4T-1X3, CA

(21) Appl. No.: 12/788,368

(22) Filed: May 27, 2010

Related U.S. Application Data
(60) Provisional application No. 61/181,393, filed on May 27, 2009.

(51) Int. Cl. H01J 49/26; H01J 49/40; H01J 49/42

(52) U.S. Cl. 250/283; 250/287; 250/292

(57) ABSTRACT

A method and apparatus for acquiring time profiles of ion intensities of product ions in a mass spectrometer is provided. The mass spectrometer comprises an ion trap, a fragmentation module connected to the ion trap, and a mass analyzer module positioned to receive ions from the fragmentation module. Precursor ions, trapped in the ion trap, are ejected from the ion trap in order of m/z ratio. At least of some the precursor ions are fragmented at the fragmentation module to form product ions. Time profiles of ion intensities of the product ions are acquired, the product ions received at the mass analyzer module, by recording a plurality of product mass spectra for each respective precursor ion. The plurality of product mass spectra is processed, using the time profile intensities, to associate respective product ions with the respective precursor ions.

### FIELD

The specification relates generally to mass spectrometry, and specifically to a method and apparatus for acquiring time profiles of ion intensities of product ions in a mass spectrometer.

### BACKGROUND

When performing mass spectrometry, multiple pre-cursor ions trapped in an ion trap are generally ejected in sequence of mass, to be fragmented and analyzed in a mass analyzer. In order to achieve a better signal at the mass analyzer, the fill time of the ion trap can be increased. However this leads to increased space charge within the ion trap, which has a detrimental effect on the mass resolution (i.e. separation of ions of different mass) of the mass spectrometer. Achieving a balance between these two effects can be challenging, especially when there is a limited amount of sample.

### SUMMARY

A first aspect of the specification provides a method of operating a mass spectrometer comprising an ion trap, a fragmentation module connected to the ion trap, and a mass analyzer module positioned to receive ions from the fragmentation module. The method comprises ejecting precursor ions, trapped in the ion trap, in order of m/z ratio. The method further comprises fragmenting at least of some the precursor ions to form product ions at the fragmentation module. The method further comprises acquiring time profiles of ion intensities of the product ions received at the mass analyzer module, by recording a plurality of product mass spectra for each respective precursor ion. The method further comprises processing the plurality of product mass spectra using the time profile intensities to associate respective product ions with the respective precursor ions.

The method can further comprise alternating between a low energy fragmentation mode and a high energy fragmentation mode, wherein during the low energy fragmentation mode a first set of the plurality of product mass spectra are associated with substantially unfragmented precursor ions, and during the higher energy fragmentation mode a second set of the plurality of product mass spectra are associated with substantially fragmented product ions, such that the respective product ions can be associated with the respective precursor ions via the first set and the second set. For every one of the first set acquired, a plurality of second sets can be acquired.

The mass analyzer module can comprise a time of flight mass analyzer.

The mass analyzer module can comprise a quadrupole mass filter operated in a multiple ion monitoring mode.

The method can further comprise identifying the respective precursor ions from a residual unfragmented precursor ion intensity in the plurality of product mass spectra.

Processing the plurality of product mass spectra can comprise deconvoluting the respective ion intensities. At least two of the time profiles of ion intensities can overlap.

Ejecting precursor ions, trapped in the ion trap, can comprise ejecting precursor ions in sequential order of m/z ratio.

The method can further comprise applying an axial field in the fragmentation module to reduce transit time of ions in the fragmentation module.

A second aspect of the specification provides a mass spectrometer. The mass spectrometer comprises an ion trap enabled to eject precursor ions, trapped in the ion trap, in order of m/z ratio. The mass spectrometer further comprises a fragmentation module, connected to the ion trap, enabled to fragment at least of some the precursor ions to form product ions. The mass spectrometer further comprises a mass analyzer module positioned to receive ions from the fragmentation module. The mass analyzer module is enabled to: acquire time profiles of ion intensities of the product ions received at the mass analyzer module, by recording a plurality of product mass spectra for respective precursor ions; and process the plurality of product mass spectra using the time profile intensities to associate respective product ions with the respective precursor ions.

The mass spectrometer can be enabled to alternate between a low energy fragmentation mode and a high energy fragmentation mode, wherein during the low energy fragmentation mode a first set of the plurality of product mass spectra are associated with substantially unfragmented precursor ions and during the higher energy fragmentation mode a second set of the plurality of product mass spectra are associated with substantially fragmented product ions, such that the respective product ions can be associated with the respective precursor ions via the first set and the second set. For every one of the first set acquired, a plurality of second sets can be acquired.

The mass analyzer module can comprise a time of flight mass analyzer.

The mass analyzer module can comprise a quadrupole mass filter operated in a multiple ion monitoring mode.

The mass analyzer module can be further enabled to identify the respective precursor ions from a residual unfragmented precursor ion intensity in the plurality of product mass spectra.

To process the plurality of product mass spectra, the mass analyzer module can enabled to deconvolute the respective ion intensities. At least two of the time profiles of ion intensities can overlap.

To eject precursor ions, the ion trap can be further enabled to eject precursor ions in sequential order of m/z ratio.

The fragmentation module can be further enabled to apply an axial field to reduce transit time there through.

### BRIEF DESCRIPTIONS OF THE DRAWINGS

Embodiments are described with reference to the following figures, in which:

FIG. 1 depicts a mass spectrometer for acquiring time profiles of ion intensities of product ions, according to non-limiting embodiments;

FIG. 2 depicts a mass ejection profile of an ion trap in the mass spectrometer of FIG. 1, according to non-limiting embodiments;

FIG. 3 depicts product ion spectra acquired according to non-limiting embodiments;

FIG. 4 depicts a time profile of product ions, according to non-limiting embodiments;

FIG. 5 depicts an example of the time profile of product ion m/z 237.3 recorded as the ion trap in the mass spectrometer of FIG. 1 is scanned slowly over m/z range 400 to m/z 402, according to non-limiting embodiments; and

FIG. 6 depicts a method for acquiring time profiles of ion intensities of product ions, according to non-limiting embodiments.

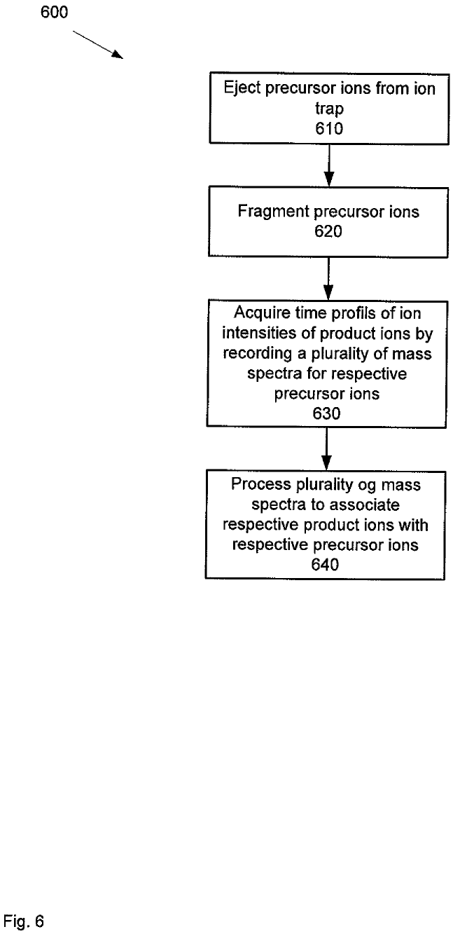

### DETAILED DESCRIPTION OF THE EMBODIMENTS

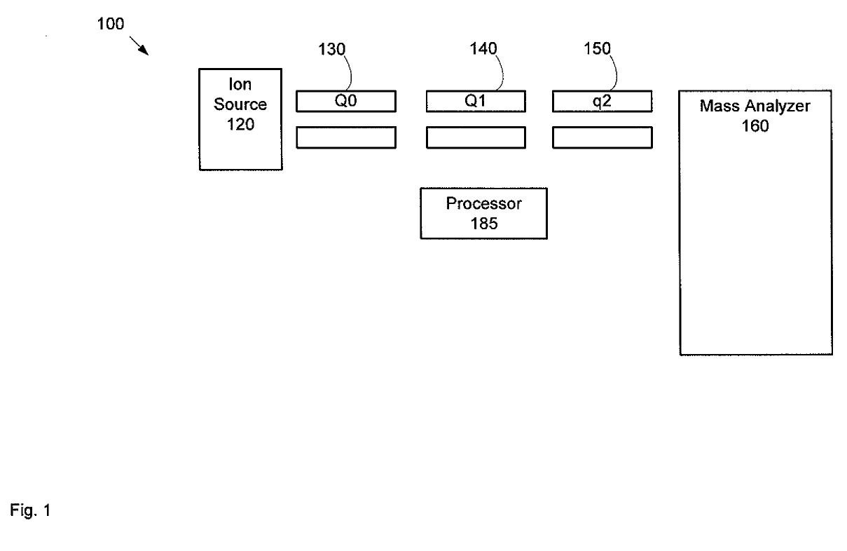

FIG. 1 depicts a block diagram of a mass spectrometer 100 for performing high resolution mass spectrometry, according to non-limiting embodiments. Mass spectrometer 100 generally comprises an ion source 120, ion optics 130, an ion trap 140, a fragmentation module 150 and a mass analyzer 160, which are generally arranged such that ions produced at ion source 120 can be transferred to mass analyzer 160 for analysis. In some embodiments, mass spectrometer 100 can further comprise a processor 185 for controlling operation of mass spectrometer 100, including but not limited to controlling ion source 120 to ionise the ionisable materials, and controlling transfer of ions between modules of mass spectrometer 100. In particular, processor 185 controls ion trap 140, as described below and is further enabled to process product mass spectra acquired via mass analyzer 160. In some embodiments, mass spectrometer 100 further comprises any suitable memory device for storing product mass spectra.

In operation, ionisable materials are introduced into ion source 120. Ion source 120 generally ionises the ionisable materials to produce precursor ions which are transferred to ion optics 130 (also identified as Q0, indicative that ion optics 130 take no part in the mass analysis). Precursor ions are transferred from ion optics 130 to ion trap 140 (also identified as Q1) enabled to eject ions (e.g. precursor ions) in order of m/z (mass to charge) ratio, in a manner described below. Ejected precursor ions can then be transferred to fragmentation module 150 (also identified as q2) for fragmentation, to form product ions. Product ions are subsequently transferred to mass analyzer 160 for mass analysis, resulting in production of product ion spectra.

Furthermore, while not depicted, mass spectrometer 100 can comprise any suitable number of vacuum pumps to provide a suitable vacuum in ion source 120, ion optics 130, ion trap 140, fragmentation module 150 and/or mass analyzer 160. It is understood that in some embodiments a vacuum differential can be created between certain elements of mass spectrometer 100: for example a vacuum differential is generally applied between ion source 120 and ion optics 130, such that ion source 120 is at atmospheric pressure and ion optics 130 are under vacuum. While also not depicted, mass spectrometer 100 can further comprise any suitable number of connectors, power sources, RF (radio-frequency) power sources, DC (direct current) power sources, gas sources (e.g. for ion source 120 and/or fragmentation module 150), and any other suitable components for enabling operation of mass spectrometer 100.

Ion source 120 comprises any suitable ion source for ionising ionisable materials. Ion source 120 can include, but is not limited to, an electrospray ion source, an ion spray ion source, a corona discharge device, and the like. In these embodiments, ion source 120 can be connected to a mass separation system (not depicted), such as a liquid chromatography system, enabled to dispense (e.g. elute) ionisable to ion source 120 in any suitable manner.

In specific non-limiting embodiments, ion source 120 can comprise a matrix-assisted laser desorption/ionisation (MALDI) ion source, and samples of ionisable materials are first dispensed onto a MALDI plate, which can generally comprise a translation stage. Correspondingly, ion source 120 is enabled to receive the ionisable materials via the MALDI plate, which can be inserted into the MALDI ion source, and ionise the samples of ionisable materials in any suitable order. In these embodiments, any suitable number of MALDI plates with any suitable number of samples dispensed there upon can be prepared prior to inserting them into the MALDI ion source.

Precursor ions produced at ion source 120 are transferred to ion optics 130, for example via a vacuum differential and/or a suitable electric field(s). Ion optics 130 can generally comprise any suitable multipole or RF ion guide including, but not limited to, a quadrupole rod set. Ion optics 130 are generally enabled to cool and focus precursor ions, and can further serve as an interface between ion source 120, at atmospheric pressure, and subsequent lower pressure vacuum modules of mass spectrometer 100.

Precursor ions are then transferred to ion trap 140, for example via any suitable vacuum differential and/or a suitable electric field(s), ion trap 140 enabled to eject precursor ions in order of m/z ratio, which are transferred to fragmentation module 150. It is understood that while ion trap 140 is identified as Q1 in FIG. 1, ion trap 140 can be an electrostatic ion trap (as generally described in U.S. Pat. No. 6,744,042) a linear ion trap (LIT), a quadrupole or 3D ion trap, an ion cyclotron resonance ion trap, or an any type of ion trapping device from which ions can be mass selectively ejected toward a fragmentation cell or collision cell.

In any event, as precursor ions are ejected from ions trap 140, they are transferred to fragmentation module 150 for fragmentation such that product ions are produced. In some embodiments, fragmentation module 150 can be operated in alternating low energy fragmentation and high energy fragmentation modes to first identify precursor (i.e. parent) ions and associated respective product ions of each mass range.

Once fragmentation of precursor ions occurs, product ions are transferred to mass analyzer 160 for analysis and production of product ion spectra (i.e. product mass spectra). Mass analyzer 160 can comprise any suitable mass spectrometer module including, but not limited to, a time of flight (TOF) mass spectrometry module, a quadrupole mass spectrometry module, a linear ion trap module and the like.

Returning now to ion trap 140, ion trap 140 is generally filled with precursor ions for a given period of time, which is understood to be the “fill time”. While longer fill times can lead to better signal to noise ratio (SNR) in spectra acquired at mass analyzer 160, as more precursor ions are available for analysis, the space charge of such degrades mass resolution as when there are too many ions in ion trap 140, the electric field within ion trap 140 becomes distorted. The relatively high space charge in ion trap 140 makes the mass selective ejection from ion trap 140 inefficient. In addition, the relatively high space charge in ion trap 140 reduces the ion selectivity of ion trap 140.

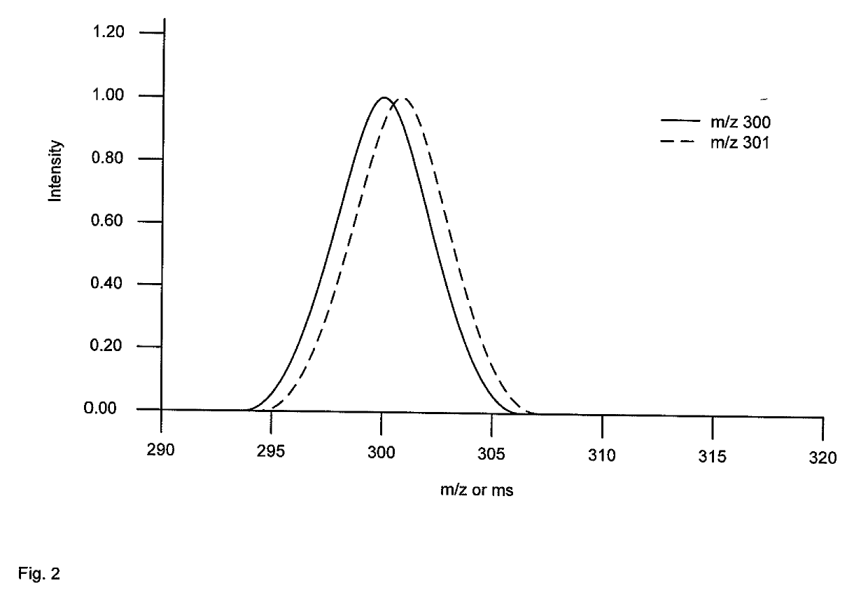

For example, in some embodiments, ion trap 140 can be operated to scan through a range of masses in steps of 1 m/z: e.g. precursor ions of m/z 300 can be first ejected, and then precursor ions of m/z 301, etc. However, space charge can limit the mass resolution such that ejection profiles of precursor ions overlap: i.e. multiple precursor ions are ejected, rather than a single precursor ion. For example, as depicted in the ejection profile of FIG. 2, while ion trap is ejecting precursor ions of m/z 300, some precursor ions of m/z 301 are also ejected. In the ejection profile of FIG. 2, it is assumed that ion trap 140 is scanned at a rate of 1000 amu/s and that the width of the m/z 300 peak is 6 ms wide at half height, and width of m/z 301 peak is 6 ms wide at half height, each peak having a mass resolution of 50 (i.e. approximately 300/6). This can make it difficult to associate fragmented product ions, identified in product mass spectra, with a precursor ion of a given m/z because the fragments of m/z 300 and ink 301 will overlap significantly in time, resulting in many product ion spectra recorded in mass analyzer 160 that contain products of both precursors.

To compensate for this effect mass analyzer 160 is enabled to acquire time profiles of ion intensities of product ions received at mass analyzer 160 by recording a plurality of product mass spectra for respective precursor ions, each mass spectrum comprising respective ion m/z and respective ion intensities of product ions. The plurality of product mass spectra are then processed using the time profiles intensities to associate respective product ions with respective precursor ions. Hence, the time-resolved signal from the mass analyzer 160 can be used to determine which product ions are formed from a particular precursor ion.

Returning to the previous example, as ion trap 140 is scanned to eject a range of ions, m/z 300 can be ejected before m/z 301, but the ejection profiles can overlap as in FIG. 2. However, the profile of the product ions recorded at mass analyzer 160 will follow the profile of the precursor ion: all of the product ions of m/z 300 will track together in time, and all of the products of m/z 301 will track together in time, even though the profiles may overlap somewhat in time. The product spectra can be deconvoluted and separated by aligning the ejection profiles of the product ions, enabling identification of product ion/precursor ion pairs even if unit mass resolution is not achieved in the ejection from ion trap 140. Furthermore, identification of the precursor ions can be obtained by observing the residual unfragmented precursor ion in the product mass spectra, or can be obtained by alternating operation of fragmentation module 150 in low collision energy/high collision energy modes in alternate ejection scans from ion trap 140.

The previous example can again be considered, where the scan speed of ion trap 140 is 1000 amu/s and hence each mass peak should be ejected in 1 ms. However, if the resolution of the ion trap is degraded by space charge or other effects that can reduce the mass resolution (non-limiting examples of effects that can degrade or reduce the resolution include fast scan speed, or non-optimum geometry of the trap), then the ejection profiles can be several ms wide, as depicted in FIG. 2, and the ejection profiles can overlap. The product ions of m/z 300 will be 1 ms ahead of the product ions of m/z 301 even if they overlap. Further consider embodiments where mass analyzer 160 is enabled to record full product ion spectra at a rate of several KHz, for example 30 KHz (e.g. when mass analyzer 160 comprises an orthogonal time-of-flight (TOF) mass analyzer). Therefore, in these embodiments, approximately 30 product spectra can be recorded in 1 ms and over the nominal 1 ms peak width of the ejected ions and fragmented product ions. If the peaks are broadened so that they overlap, as shown in FIG. 2, and are several ms wide, then the time profiles of the product ions recorded at 30 KHz, or a rate of 30 spectra per ms, can be used to identify which product ions come from the m/z 300 precursor and which product ions come from the m/z 301 precursor.

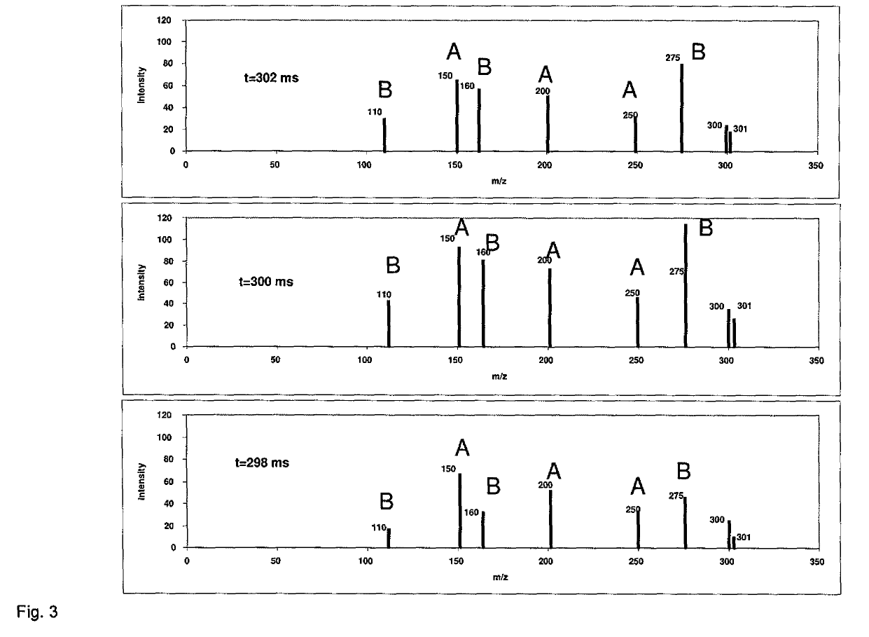

To illustrate this, attention is directed to FIG. 3, which depicts product mass spectra acquired at t=298 ms, t=300 ms and t=302 ms. It is understood that, in some exemplary embodiments, mass spectra are acquired continuously at a rate of 30 spectra per ms by the mass analyzer 160 during the course of a 1000 amu scan by the ion trap 140, which is scanned at a rate of 1000 amu/second (or 1 amu per ms). During the 1000 amu scan by ion trap 140, 30,000 product mass spectra of product ions are acquired by mass analyzer 160 and associated detector. It is further understood that the product mass spectra depicted in FIG. 3 are exemplary only, and can comprise any suitable number of peaks and/or background noise. In FIG. 3 it is assumed that precursor ions of m/z 300 to 301 are scanned from the ion trap (as suggested by the example shown in FIG. 2), but each amu mass peak is stretched over a time period that is 6 ms in half width, as shown in FIG. 2.

In any event, signals for species labelled A and B are recorded at t=298 ms by mass analyzer 160, along with residual unfragmented precursor signals at m/z 300 and 301 (it is assumed for the purpose of this example that there are no other precursor ions between m/z 290 and m/z 310). At t=298 ms, product ion peaks (signals) associated with species A with precursor m/z of 300 are increasing in intensity while product ion peaks (signals) associated with species B with precursor m/z of 301 are also increasing in intensity. Unfragmented (residual) precursor ions of m/z 300 and m/z 301 are present together, indicating that both precursor ions are being ejected from ion trap 140 at this time. In the scan recorded at t=300, product ion peaks associated with species A have reached a maximum intensity, while species labelled B continue to increase in intensity.

In the scan recorded at t=302 ms, intensities of product ion peaks associated with species

A and with species B are both decreasing.

In processing the spectra acquired by mass analyzer 160, of which those shown in FIG. 3 are examples, the time profiles of ion intensities of all product ions can be plotted or processed in order to determine their time profiles. In the example of FIG. 3, product ion species in each of the scans acquired at t=298, 300 and 302 ms, can be associated with respective precursor ions, as the signals for product ions will follow a time profile similar to that of the precursor ion signals. For example, in FIG. 3, signals for product ion species labelled A increase or decrease as the signal for precursor ion 300 m/z increases or decreases; hence product ion species labelled A can be associated with precursor ion of 300 m/z (i.e. product ion species labelled A can be identified as having been fragmented from precursor ion of 300 m/z). Similarly, signals for product ion species labelled B increase or decrease as the signal for precursor ion 301 m/z increases or decreases; hence product ion species labelled B can be associated with precursor ion of 301 m/z (i.e. product ion species labelled B can be identified as having been fragmented from precursor ion of 301 m/z).

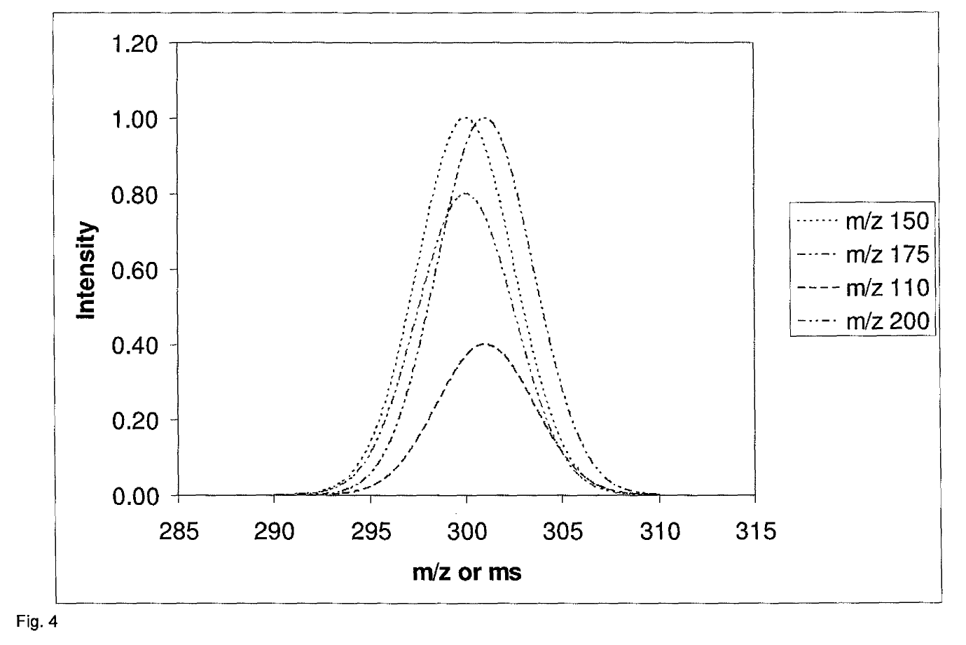

Such association can be performed by deconvoluting the time profiles of the product ions in the scans acquired at t=298, 300 and 302 ms. For example, in some embodiments, signals of product ions, associated with different precursor ions, can overlap; in these embodiments, deconvolution of such overlapping signals can be performed to distinguish between them. For example, product mass spectra time profiles of some of the product ions in the example of FIG. 3 can be plotted as shown in FIG. 4. The intensities of product ions of m/z 150 and m/z 200 reach a maximum when precursor ions of 300 m/z are being ejected from ion trap 140, while intensities of product ions of m/z 110 and m/z 275 reach a maximum when precursor ions of 301 m/z are being ejected from ion trap 140. Therefore product ions of adz 150 and m/z 200 can be associated with precursor ion m/z 300, while product ions of m/z 110 and m/z 275 can be associated with precursor ion m/z 301.

In some embodiments, fragmentation module 150 comprises a collision induced dissociation (CID) collision cell. In these embodiments, the transit time through the collision cell can be relatively short, so that the signals/peaks are not further broadened in transit. For example, ions can move through the collision cell in approximately 1 ms. If the transit time is too long, then mobility separation of ions may cause the product ion profiles to fail to track one another. Ions of different mobility will cause the profiles to separate. To reduce the transit time, an axial field can be applied in the collision cell. Any further overlap of ion profiles from different precursor ions, caused by broadening during transit through the collision cell, can be deconvoluted using the method of aligning ion current profiles.

In embodiments, fragmentation can occur via a process that does not change the velocity of the ions, for example fragmentation module 1650 can comprise a photofragmentation module. In these embodiments, product ions move at the same speed as precursor ions, and no time-separation occurs.

In some embodiments, there may be no unfragmented or residual precursor ions remaining in the product ion spectra. This can happen if the collision energy or fragmentation efficiency is very high. In such cases, alternate scans at low collision energy and high collision energy (sufficient to fragment ions), can be acquired, such that one set of spectra will contain precursor ion peaks and one set of spectra will contain product ions with some residual precursors ion peaks. This can allow the time profiles of precursor ions to be acquired independently of the product ions so that they can be aligned in order to associate specific product ion m/z values with specific precursor ion ink values. In some of these embodiments, the time profiles may not exactly match up because the initial energy in the collision cell is higher at higher collision energies. Hence, the low and high energy spectra can appear to be shifted in time. This time shift can be compensated for by a calibration process (e.g. calibrating time vs. energy of ions travelling through fragmentation module 150) and/or by shifting and aligning the two set of spectra.

Furthermore, there can be a duty cycle advantage to operating mass spectrometer 100 in this manner as the fill time can be increased. Such an advantage can be shown via a non-limiting exemplary calculation: Assume that the scan time of ion trap 140 is 500 ms (e.g. ion trap 140 scans through 500 amu at 1000 amu/s). Further assume that the fill time of ion trap 140 is 10 ms. Then the duty cycle will be 10 ms/500 ms or 2%. In comparison with conventional operation of a mass spectrometer for performing MSMS of everything which would acquire MSMS of each precursor m/z value for 1 ms each, this represents an increase of a factor of 10 in duty cycle and sensitivity. By increasing the fill time further, the duty cycle can be further increased; however the maximum fill time can be dependent on the space charge limit of ion trap 140. Since space charge limits the mass resolution, the limit in fill time will be determined by the ion current and by a minimum mass resolution that can be deconvoluted in acquired product mass spectra.

Furthermore, scan rate can be increased to further increase the duty cycle as: for example a scan of 4000 amu/s represents a scan time of 125 ms for a mass range of 500 amu. Then the duty cycle can be 8% (e.g. 10 ms/125 ms).

In other embodiments, various methods can be used to limit the space charge and therefore enable higher duty cycles, including but not limited to eliminating low mass ions by using a low mass cut-off and selectively ejecting specific intense background ions prior scanning.

In yet further embodiments, operation of mass spectrometer 100 to acquire time profiles of product spectra can be used in combination with selective isolation of specific mass ranges in order to eliminate unwanted ions. For example, a Filtered Noise Field (FNF) can be used to isolate specific mass windows around mass peaks of interest. Then a fast scan of ions in ion trap 140 can be performed to sequentially eject ions. In some of these embodiments, some regions of the spectrum can be empty, simplifying the alignment of the product ions with the respective precursor ions.

In some embodiments, operation of mass spectrometer 100 to acquire time profiles of product spectra can be used to obtain very fast MSMS scans under conditions where a high scan speed may result in decreased mass resolution. For example, at a scan speed of 10000 amu/s, unit mass resolution may not be achieved, even at low ion concentrations and ejected product ions will overlap. Deconvolution of a plurality of product mass spectra for precursor ions (i.e. from an acquired time profile) can be used to associate product ions with respective precursor ions. In these embodiments, the transit time of ions through fragmentation module 140 can contribute to broadening of the ejection profiles. However, alignment of the time profiles of the product ions can still allow the product ions to be assigned to specific precursor m/z values.

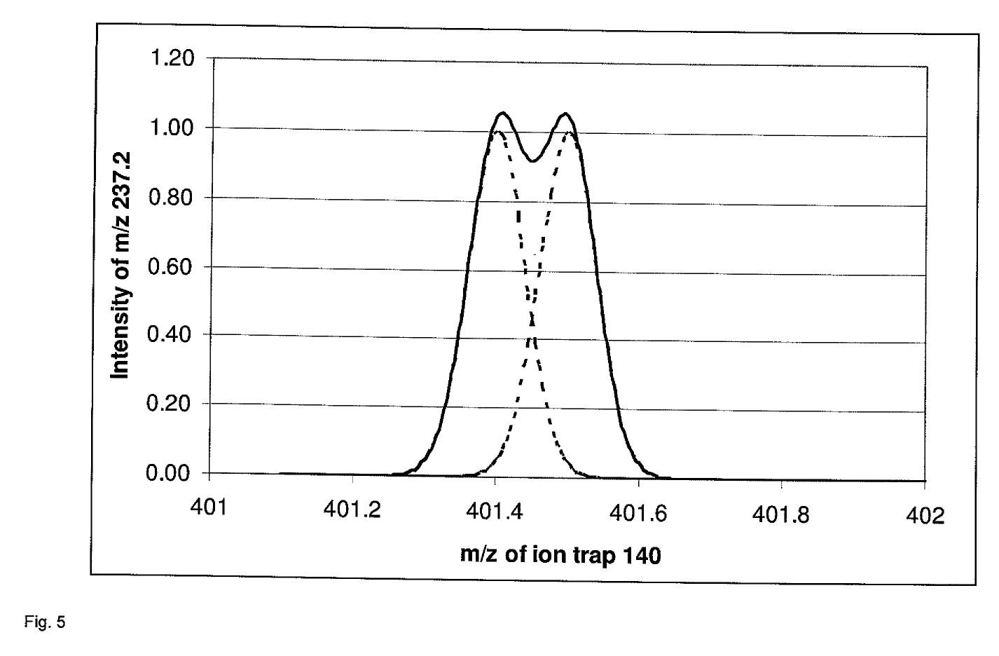

In embodiments where it is desired to obtain high mass resolution in a particular mass range, the scan rate of ion trap 140 can be lowered. For example, if a narrow mass range is scanned slowly, for example at 10 amu/sec, peak widths of <0.1 amu can be achieved. This can increase the signal-to-noise ratio (S/N) in complex samples. Aligning the profiles of the product ions of the ejected precursor ions can further increase the resolution, which also leads to better specificity by recording the time profile of product ions, as well as the product ion mass value, when ions are scanned from ion trap 140. It is understood, however, that the time resolution of mass analyzer 160 is on the order of, or faster than, the ejection profile of ion trap 140. For high resolution multiple reaction monitoring (MRM) acquisitions using mass analyzer 160 as a mass filter as the ejection profile of product ions can be measured by rapidly peak hopping the m/z value of mass analyzer 160 among the target product ion m/z values. This is similar to conventional MRM analysis except that ion trap 140 is slowly scanned over a narrow mass range around a known precursor m/z value. If there are two isobaric compounds with slightly different exact m/z values, one of which is a target m/z of interest, and one of which is a background or interference ion, both of which form a product ion of exactly the same m/z value, then the time profiles of the two product ions will be different, following the time profiles of the two precursor ions of slightly different m/z. The time profile of the product ion m/z can be deconvoluted to reduce or eliminate the interference. For example FIG. 5 shows an example of the time profile of product ion m/z 2373 recorded as ion trap 140 is scanned slowly over m/z range 400 to m/z 402. The time profile of m/z 237.2 (solid line) shows 2 maxima, suggesting 2 overlapping peaks. The time profile can be deconvoluted as shown into two overlapping peaks using known mathematical deconvolution methods, to produce the two time profiles shown as dotted lines. Then intensity of the product ion intensity from the target precursor ion can be measured without interference from the product ion due to the background or interference ion. In other embodiments where it is desired to obtain high mass resolution, mass analyzer 160 can be a TOF or other fast scanning mass spectrometer, and full product ions spectra can be acquired during the slow scan of ion trap 140. Deconvolution of the overlapping product ion time profiles acquired from the full product ions spectra can be performed to identify the target precursor ion without interference from the background or interference ion.

Attention is now directed to FIG. 5 which depicts a method 600 for operating a mass spectrometer comprising an ion trap. In order to assist in the explanation of the method 600, it will be assumed that the method 600 is performed using mass spectrometer 100. Furthermore, the following discussion of the method 600 will lead to a further understanding of mass spectrometer 100 and its various components. However, it is to be understood that mass spectrometer 100 and/or method 600 can be varied, and need not work exactly as discussed herein in conjunction with each other, and that such variations are within the scope of present embodiments.

At step 610, precursor ions are ejected from ion trap 140, in order of m/z ratio. It is understood that precursor ions have been produced at ion source 140, and transferred to ion trap 140, using a given fill time. In general precursor ions are ejected from ion trap 140 and transferred to fragmentation module 150.

At step 620, at least some of the precursor ions are fragmented, to form product ions, at fragmentation module 150. It is understood that product ions are then transferred to mass analyzer 160.

At step 630, time profiles of ion intensities of product ions received at mass analyzer 160 are acquired by recording a plurality of product mass spectra for respective precursor ions (e.g. spectra acquired at a rate of several KHz, as described above), product mass spectra comprising respective ion ink and respective ion intensities of product ions, for example as depicted in FIG. 3.

At step 640, the plurality of product mass spectra are processed using the time profiles intensities to associate respective product ions with respective precursor ions as depicted in FIG. 4.

In some embodiments, method 600 can further comprise alternating operation of mass spectrometer 100 between a low energy fragmentation mode and a high energy fragmentation mode. During the low energy fragmentation mode, a first set of the plurality of product mass spectra are associated with substantially unfragmented precursor ions. During the higher energy fragmentation mode, a second set of the plurality of product mass spectra are associated with substantially fragmented product ions, such that the respective product ions can be associated with the respective precursor ions via the first set and the second set. For example, at the beginning of each step of a mass ejection scan in ion trap 140 (i.e. for each precursor ion ejected), fragmentation module 150 can first be controlled to allow precursor ions to be transferred there through without substantial fragmentation. Once an initial product mass spectra is acquired at mass analyzer 160, the initial product mass spectra substantially comprising a signal of at least one precursor ion, fragmentation module 150 is then controlled to produce fragmented product ions. Subsequent product mass spectra acquired at mass analyser 160 can then be associated with the at least one precursor ion identified in the initial scan. Any suitable number of alternations between a low energy fragmentation mode and a high energy fragmentation mode are within the scope of present embodiments. Furthermore, each of the first set and the second set of the plurality of product mass spectra can comprise any suitable number of spectra. In some non-limiting embodiments, for every one of the first set acquired, a plurality of second sets are acquired.

In general, method 600 can further comprise identifying the respective precursor ion from a residual unfragmented precursor ion intensity in the plurality of product mass spectra, as described above with reference to FIG. 3. Furthermore, processing the plurality of product mass spectra can comprise deconvoluting the respective ion intensities, including but not limited to deconvoluting the respective ion intensities when at least two of the time profiles of ion intensities overlap.

In any event, space charge or other limitations of ion trap 140 an be obviated by acquiring a time profile of ion intensities of product ions received at a mass analyzer, and specifically by recording a plurality of product mass spectra for respective precursor ions ejected from ion trap 140, each product mass spectra comprising respective ion m/z and respective ion intensities of the product ions. The plurality of product mass spectra can be processed using the time profile intensities to associate respective product ions with respective precursor ions. Hence, the fill time of the ion trap 140 can be increased, and slower mass ejection scan speeds used, both of which increase the duty cycle of mass spectrometer 100.

Those skilled in the art will appreciate that in some embodiments, the functionality of mass spectrometer 100 can be implemented using pre-programmed hardware or firmware elements (e.g., application specific integrated circuits (ASICs), electrically erasable programmable read-only memories (EEPROMs), etc.), or other related components. In other embodiments, the functionality of mass spectrometer 100 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Alternatively, the computer-readable program code could be stored remotely but transmittable to these components via a modem or other interface device connected to a network (including, without limitation, the Internet) over a transmission medium. The transmission medium can be either a non-wireless medium (e.g., optical and/or digital and/or analog communications lines) or a wireless medium (e.g., microwave, infrared, free-space optical or other transmission schemes) or a combination thereof.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

What is claimed is:

1. A method of operating a mass spectrometer comprising an ion trap, a fragmentation module connected to said ion trap, and a mass analyzer module positioned to receive ions from said fragmentation module, the method comprising:
ejecting precursor ions, trapped in said ion trap, in order of m/z ratio;
fragmenting at least of some said precursor ions to form product ions at said fragmentation module;
acquiring time profiles of ion intensities of said product ions received at said mass analyzer module, by recording a plurality of product mass spectra for each respective precursor ion;
processing said plurality of product mass spectra using said time profile intensities to associate respective product ions with said respective precursor ions.

2. The method of claim 1, further comprising alternating between a low energy fragmentation mode and a high energy fragmentation mode, wherein during said low energy fragmentation mode a first set of said plurality of product mass spectra are associated with substantially unfragmented precursor ions, and during said higher energy fragmentation mode a second set of said plurality of product mass spectra are associated with substantially fragmented product ions, such that said respective product ions can be associated with said respective precursor ions via said first set and said second set.

3. The method of claim 2, wherein for every one of said first set acquired, a plurality of second sets are acquired.

4. The method of claim 1, wherein said mass analyzer module comprises a time of flight mass analyzer.

5. The method of claim 1, wherein said mass analyzer module comprises a quadrupole mass filter operated in a multiple ion monitoring mode.

6. The method of claim 1, further comprising identifying said respective precursor ions from a residual unfragmented precursor ion intensity in said plurality of product mass spectra.

7. The method of claim 1, wherein said processing said plurality of product mass spectra comprises deconvoluting said respective ion intensities.

8. The method of claim 7, wherein at least two of said time profiles of ion intensities overlap.

9. The method of claim 1, wherein said ejecting precursor ions, trapped in said ion trap, comprises ejecting precursor ions in sequential order of m/z ratio.

10. The method of claim 1, further comprising applying an axial field in said fragmentation module to reduce transit time of ions in said fragmentation module.

11. A mass spectrometer comprising:
an ion trap enabled to eject precursor ions, trapped in said ion trap, in order of m/z ratio;
a fragmentation module, connected to said ion trap, enabled to fragment at least of some said precursor ions to form product ions;
a mass analyzer module positioned to receive ions from said fragmentation module, said mass analyzer module enabled to:
acquire time profiles of ion intensities of said product ions received at said mass analyzer module, by recording a plurality of product mass spectra for each respective precursor ion; and
process said plurality of product mass spectra using said time profile intensities to associate respective product ions with said respective precursor ions.

12. The mass spectrometer of claim 11, wherein said mass spectrometer is enabled to alternate between a low energy fragmentation mode and a high energy fragmentation mode, wherein during said low energy fragmentation mode a first set of said plurality of product mass spectra are associated with substantially unfragmented precursor ions and during said higher energy fragmentation mode a second set of said plurality of product mass spectra are associated with substantially fragmented product ions, such that said respective product ions can be associated with said respective precursor ions via said first set and said second set.

13. The mass spectrometer of claim 12, wherein for every one of said first set acquired, a plurality of second sets are acquired.

14. The mass spectrometer of claim 11, wherein said mass analyzer module comprises a time of flight mass analyzer.

15. The mass spectrometer of claim 11, wherein said mass analyzer module comprises a quadrupole mass filter operated in a multiple ion monitoring mode.

16. The mass spectrometer of claim 11, wherein said mass analyzer module is further enabled to identify said respective precursor ions from a residual unfragmented precursor ion intensity in said plurality of product mass spectra.

17. The mass spectrometer of claim 11, wherein to process said plurality of product mass spectra, said mass analyzer module is enabled to deconvolute said respective ion intensities.

18. The mass spectrometer of claim 17, wherein at least two of said time profiles of ion intensities overlap.

19. The mass spectrometer of claim 11, wherein to eject precursor ions, said ion trap is further enabled to eject precursor ions in sequential order of m/z ratio.

20. The mass spectrometer of claim 11, wherein said fragmentation module is further enabled to apply an axial field to reduce transit time there through.
